(19) United States
(12) Patent Application Publication
(10) Pub. No.: US 2018/0109765 A1
(43) Pub. Date: Apr. 19, 2018

(54) Forensic Wearable Body Camera

(71) Applicant: Ted Wu, San Mateo, CA (US)

(72) Inventor: Ted Wu, San Mateo, CA (US)

(21) Appl. No.: 15/292,820

(22) Filed: Oct. 13, 2016

(51) Int. Cl. H04N 7/18; H04N 5/225

(52) U.S. Cl. CPC H04N 7/185; H04N 5/2256; H04N 5/2254; H04N 5/2252

(57) ABSTRACT

A forensic wearable body camera for recording still pictures, video and audio signals, having a dustproof and waterproof housing, a lens assembly and illumination means located on a front surface of said housing. The camera also includes a HDMI port for connecting said camera to a walkie-talkie radio, a push to talk button, a microphone and a speaker. The camera may include a detachable module attached to the back side of said camera and be further connected to a clothing.

### RELATED APPLICATIONS

This non-provisional patent application claims priority benefit of earlier-filed U.S. Provisional Patent Application No. 62/366,924, filed Jul. 26, 2016, and entitled “TRUE SOURCE PRO FORENSIC WEARABLE BODY CAMERA”. The identified earlier-filed provisional patent application is hereby incorporated by reference in its entirety into the present application.

### BACKGROUND

### 1. Technical Field

The present invention relates to a portable system for recording videos and sound. More particularly, embodiments of the invention relate to a portable video recording system sized to be worn on a user's body and configured to be mounted in a plurality of locations on the user's body, such as a clothing article worn by the user.

### 2. Related Art

Law enforcement officers are required to carry a great deal of tools and accessories, to perform their daily duties, such as video camera, audio recorder, walkie-talkie, multiple forensic lighting devices for illuminating dark spaces, etc. All of this equipment adds up to unnecessary bulk and added weight that the officer must carry, either by hand or on their body, during their entire shift. Other problems law enforcement officers face is quick and easy attachment of their body worn cameras to their clothing, breaking the device when dropped and keeping water out of the electronic areas.

Most known body worn cameras attach using spring clips that require some sort of a break or seam in the clothing, such as button up seam, zipper or pocket. Some devices (Watch Guard Vista http://watchguardvideo.com/vista/overview) use needles or pins to penetrate the officers clothing for a secure attachment. This type of attachment is not only dangerous to the officer, should an assailant remove it from their clothing and use it against the them, it also can permanently damage the clothing over the course of continued removal and re-attachment.

The object of the present invention is to provide a wearable body camera that safely, accurately and easily records events during a law enforcement officer's shift and minimizes the amount of gear that the officer must carry.

### SUMMARY OF INVENTION

A forensic wearable body camera for recording still pictures, video and audio signals, and comprising a dustproof and waterproof housing, a lens assembly and illumination means located on a front surface of said housing; and a HDMI port for connecting said camera to a walkie-talkie radio, a push to talk button, a microphone and a speaker; and a detachable module attached to the back side of said camera.

The forensic wearable body camera includes illumination means having a white LED having a low, medium, high and strobe illumination modes, an UV LED, green, blue and red LEDs. The forensic wearable body camera also comprises a monochrome LCD located on the top surface of said housing. The forensic wearable body camera also contains concealed magnets for attaching the detachable module. The detachable module includes either a touch screen LCD, or a 4G LTE, or an additional battery, or their combination.

The present invention also includes a cradle attached to the camera and a clothing attachment mechanism attached to the cradle. The clothing attachment mechanism is comprised of an inside magnetic plate and an outside magnetic plate, and wherein said outside magnetic plate is attached to the clothing by sandwiching it between the magnetic plates. Alternatively, said clothing attachment mechanism could be a spring clip assembly or include hook and loop fasteners.

### BRIEF DESCRIPTION OF THE DRAWINGS

Additional advantages and features of the invention are revealed in the claims and the following description of a preferred exemplary embodiment of the invention that is explained with reference to the drawings, in which:

FIG. 1 is a perspective view of the forensic wearable body camera of the present invention.

FIG. 2 is another perspective view of the forensic wearable body camera of the present invention.

FIG. 3 is a perspective view of a low portion of the forensic wearable body camera of the present invention.

FIG. 4 is a perspective view of a cradle of the forensic wearable body camera of the present invention.

FIG. 5 is a perspective view of the forensic wearable body camera of the present invention attached to a cradle and to magnetic plates.

FIG. 6 is a perspective view of the magnetic plates of the wearable body camera of the present invention.

FIG. 7 is a perspective view of the attached magnetic plates of the forensic wearable body camera of the present invention.

FIG. 8 is another perspective view of the magnetic plates of the forensic wearable body camera of the present invention.

FIG. 9 is a view of the backside of the forensic wearable body camera of the present invention.

FIG. 10 is a view of the front side of a detachable module of the forensic wearable body camera of the present invention.

FIG. 11 is another view of the backside of the forensic wearable body camera of the present invention.

FIG. 12 is another view of the front side of a detachable module of the forensic wearable body camera of the present invention.

FIG. 13 is a view of the spring clip assembly of the forensic wearable body camera of the present invention.

FIG. 14 is a view of the backside of the cradle of the forensic wearable body camera of the present invention.

FIG. 15 is a view of the hook and loop connector of the forensic wearable body camera of the present invention.

FIG. 16 is a view of the monochrome LCD of the forensic wearable body camera of the present invention.

FIG. 17 is a view of the top surface of the forensic wearable body camera of the present invention.

### DETAILED DESCRIPTION

In the following detailed description of the invention, numerous specific details are set forth in order to provide a thorough understanding of the invention. However, it will be obvious to one skilled in the art that the invention may be practiced without these specific details. In other instances, well known methods, procedures, components, and elements have not been described in detail so as not to unnecessarily obscure aspects of the invention.

It will be readily understood that the components of the present invention, as generally described and illustrated in the figures, may be arranged and designed in a wide variety of different configurations. Thus, the following more detailed description of the embodiments of the apparatus and methods of the present invention, as represented in the figures, is not intended to limit the scope of the invention, but is merely representative of selected embodiments of the invention.

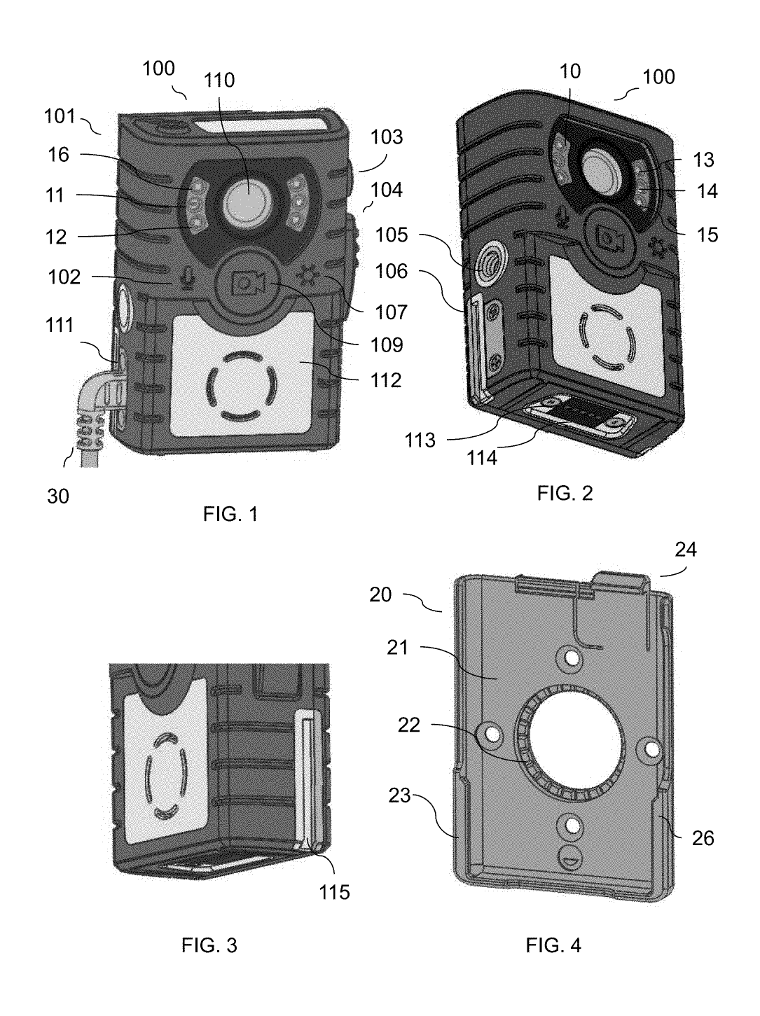

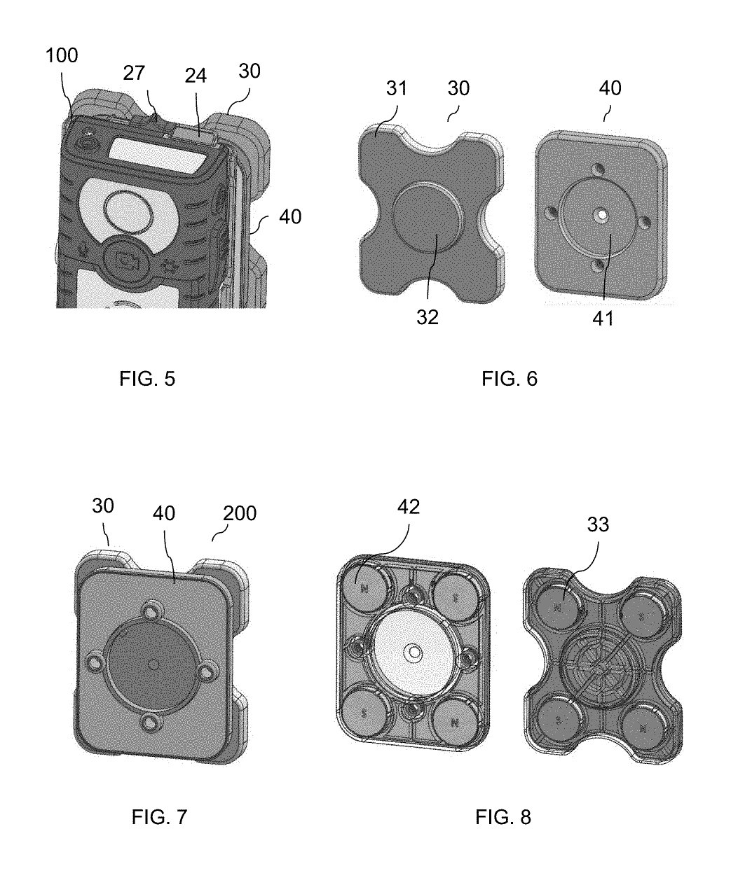

Referring now to the drawings, FIG. 1 shows a forensic wearable camera 100 of the present invention. The camera 100 is adapted to record video, audio and still pictures. The camera 100 comprises a rigid, dustproof and waterproof housing 101, preferably made from a plastic material. The camera 100 also comprises a lens assembly 110, a recording indicator 11 and illumination means 10 located on the front surface of said housing 101. The illumination means 10 provides a hands free illumination and comprises a white LED 16 having at least four illumination modes: low, medium, high and strobe. The strobe mode is used for temporarily blinding a person looking at the light. The illumination means 10 further comprises a red light LED 12 for low light tasks such as reading or communicating. The illumination means 10 also include green 13 and blue 15 LEDS for additional illumination. The illumination means 10 further includes an UV LED 14 for illuminating and detecting bodily fluids.

The camera 100 also includes an audio record button 102, a video record button 109, a LED on/off button 107 and a still picture button 103.

The camera 100 further includes a HDMI port 111 for connecting to other devices. The camera 100 may be connected by a HDMI cable 30 to the officer's walkie-talkie radio, thus allowing communication with the dispatch and fellow officers, via a microphone 119 and a speaker 112, by pressing a push to talk (PTT) button 104.

The camera 100 also includes a mounting thread 105 for attaching it to a mounting device. The camera 100 also includes a charging and data transfer port 114 that may be attached to a charger or another data transfer port by magnetic connectors 113.

The camera 100 further include a mode selector 120 and a monochrome LCD 80 located on top surface of the housing 101. The selector 120 controls the operation of the camera 100 by selecting desired modes of operation. Some operational modes and statuses are displayed by associated icons 81-92 that appear on the LCD 80. These may include the following: airplane mode 81, stealth mode 82, lock 83, timer/counter 84, battery level 85, Wi-Fi indicator 86, audio record status 87, data status 88, memory status 89, video record status 90, 4G status 91 and GPS status 92.

In an embodiment of the present invention, the camera 100 may be attached to a cradle 20 by sliding the rails 23, 26 of the cradle 20 into the grooves 106, 115 of the camera 100. The camera 100 is further secured to the cradle 20 by engaging a flexible connector 24 that attaches to the top groove 121 of the camera 100. The flexible connector 24 could be further secured to the camera 100 by a lock mechanism 27 that slides towards the flexible connector 24 and prevents it from disengaging from the camera 100.

Another embodiment of the present invention includes a plurality of detachable modules that could be connected to a wearable body camera.

The modules may include a touch screen LCD, 4G LTE, additional battery or any combination of these features. All modules share the same size, footprint, attachment and connection details.

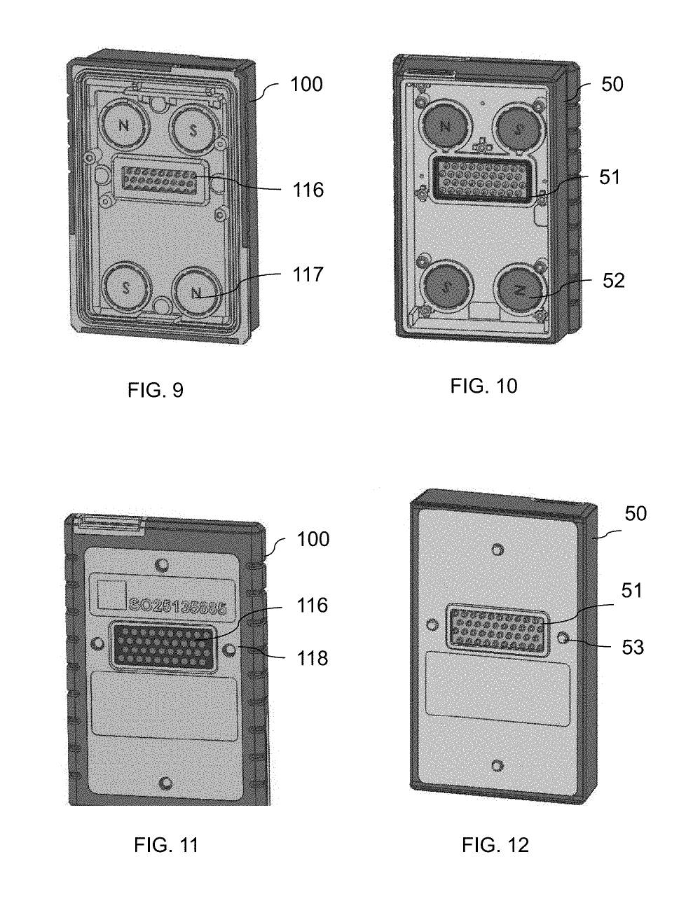

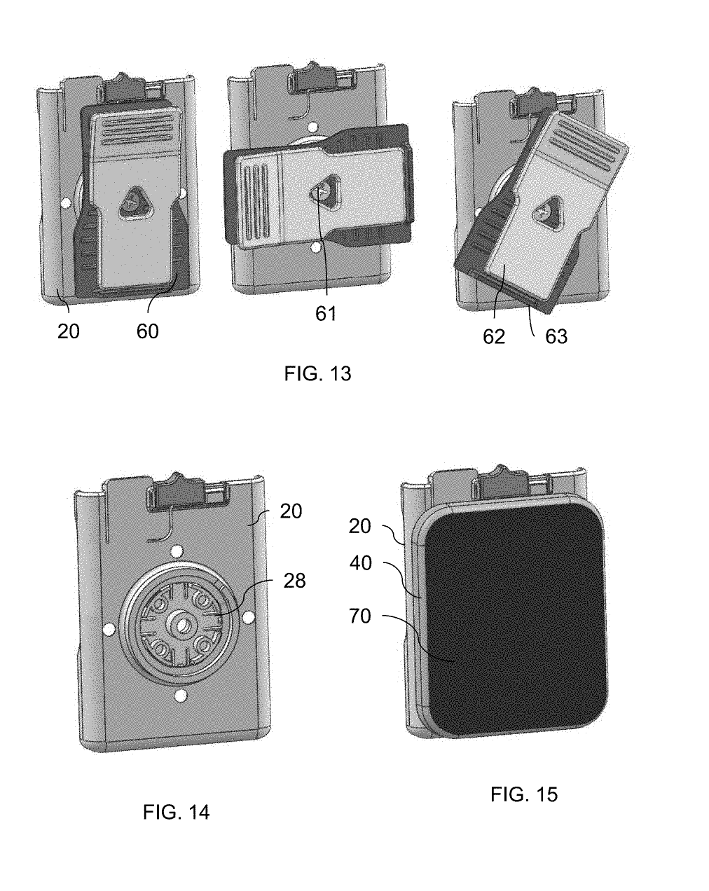

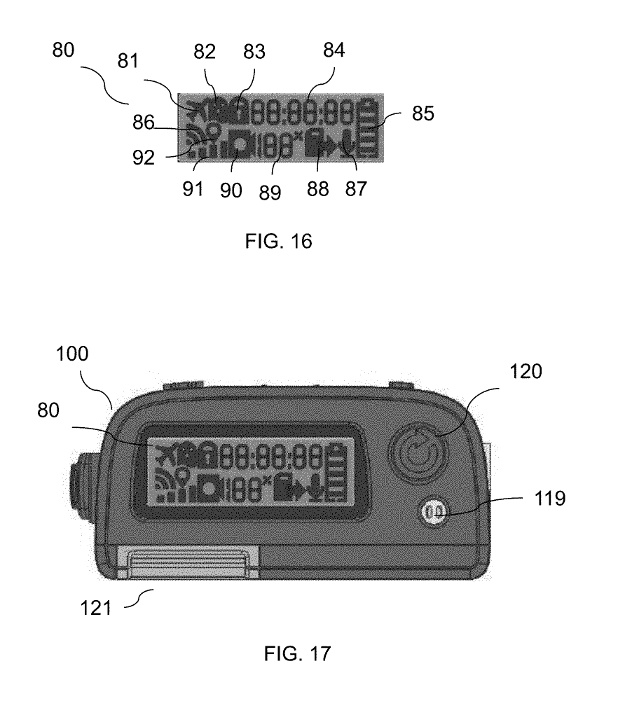

FIG. 9 shows a backside of the housing 101. There are four concealed magnets 117 assembled within the back side of the housing 101 of the wearable camera 100 and four concealed magnets 52 assembled within the front side of module 50. The polarity of the magnets 117 in the camera 100 align with the polarity of the magnets 52 in the module 50 to ensure a perfect and easy alignment every time. Molded pocket details 118 between the camera 100 and pins 53 molded in the module 50 interface to ensure they stay aligned to each other and prevent sliding or turning. All of these features ensure a proper electrical connection alignment between the rear connector 116 of the camera 100 and the front connector 51 of the module 50.

Because the wearable camera 100 houses magnets 117 within the back side of the housing 101, as described above, the user can attach the camera 100 to any ferrous surface and use any of its functions as a hands free non-wearable device. It can be used as a stealth video camera, audio recorder or illumination device to survey a room or area in a covert manor.

The present invention also includes a clothing attachment mechanism 200 comprised of an inside magnetic plate 30 and an outside magnetic plate 40.

The inside and outside magnetic plates 30, 40 house four concealed magnets 33, 42 each. The polarity of the magnets 33 housed within the inside plate 30 align with the polarity of the magnets 42 housed within the outside plate 40. To attach to clothing, the inside magnetic plate 30 is placed under the clothing, the outside magnetic plate 40 is placed over the inside magnetic plate 30, on the outside of the clothing. The magnetic attraction pulls the plates 30, 40 tightly together, sandwiching the clothing between them. The inside magnetic plate 30 features a molded embossed detail 32 that interacts with a debossed detail 41 molded onto the outside magnetic plate 40. The interaction between these details 32, 41 forces the clothing fabric to deform around them and provides additional locking force to the clothing. This helps to prevent the attachment from sliding, twisting, turning or moving during use. The deformation of the clothing is not permanent and returns to its previous condition when the magnetic plates 30, 40 are removed. The magnetic plates 30, 40 are designed small enough to comfortably and easily fit in a chest pocket, pant pocket, cargo pocket, sleeve, pant leg or most any other clothing location.

The outside magnetic plate 40 is pivotally attached to the cradle 20 with incremental detents 22 for easy adjusting once attached to the clothing. Because of the high attraction force between the magnetic plates 30, 40, their outer shape is designed such that it allows the user to remove them by pressing and holding any corner 31 of the inside magnetic plate 30 under the clothing with one hand, and lifting outward at the center of the outside magnetic plate 40 with the other hand. Another option for detaching the plates 30, 40 from its user's clothing is to rotate plates 30, 40 in opposite directions. Once the plates 30, 40 have rotated to where the magnets located in diagonal opposite corners would become aligned, their opposite magnetic poles will force them apart and away from the clothing.

In yet another embodiment of the present invention, the cradle 20 is designed to be easily interchangeable with other types of attachment components. A spring clip assembly 60 can be easily attached to the cradle 20 using a connector 61 and rotates 360° about the backside of the cradle 20 via an indexing disc 28. This allows attachment at any orientation on a person's clothing whether it be horizontal, like the top flap of a pocket, or vertical, like a button seam or zipper seam, or any other orientation as needed. Some officers wear cargo type clothing with pockets and straps sewn onto their sleeves and pant legs. In many cases, the spring clip assembly 60 can attach to these areas as well. The spring clip assembly 60 is also designed to firmly attach to a MOLLE vest by sliding one of the jaws 62 through the strap on the vest. The spring force clamps the clip assembly 60 onto the strap, and a rib 63, molded onto the opposing jaw, is positioned under the strap, locking it into place. Once the camera 100 is attached, it can be pivoted for proper orientation as needed.

In yet another embodiment of the present invention, another means of attachment can be a hook and loop (Velcro). Many law enforcement officers' ballistic and utility vests employ hook and loop panels sewn onto them for attaching accessories. In this embodiment a hook and loop panel 70 is attached to the outside magnetic plate 40 that, in turn, attaches to the hook and loop panel worn on the officer.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features.

1. A forensic wearable body camera for recording still pictures, video and audio signals, and comprising:
a. a dustproof and waterproof housing, a lens assembly and illumination means located on a front surface of said housing; and
b. a HDMI port for connecting said camera to a walkie-talkie radio, a push to talk button, a microphone and a speaker; and
c. a detachable module attached to the back side of said camera.

2. The forensic wearable body camera of claim 1, wherein said illumination means include a white LED having a low, medium, high and strobe illumination modes, an UV LED, green, blue and red LEDs.

3. The forensic wearable body camera of claim 2 further comprising a monochrome LCD located on the top surface of said housing.

4. The forensic wearable body camera of claim 3, wherein said back side of the camera contains concealed magnets for attaching the detachable module.

5. The forensic wearable body camera of claim 4, wherein said detachable module includes either a touch screen LCD, or a 4G LTE, or an additional battery, or their combination.

6. A forensic wearable body camera system comprising the camera of claim 4, a cradle attached to the camera and a clothing attachment mechanism attached to the cradle.

7. The forensic wearable body camera system of claim 6, wherein said clothing attachment mechanism is comprised of an inside magnetic plate and an outside magnetic plate, and wherein said outside magnetic plate is attached to the clothing by sandwiching it between the magnetic plates.

8. The forensic wearable body camera system of claim 6, wherein said clothing attachment mechanism is a spring clip assembly.

9. The forensic wearable body camera system of claim 6, wherein said clothing attachment mechanism comprises a hook and loop fasteners.
